(19) United States
(12) Patent Application Publication
(10) Pub. No.: US 2026/0314863 A1
(43) Pub. Date: Oct. 15, 2026

(54) Knife Sleeve Garlic Masher

(71) Applicant: RACHEL ELIZABETH NIEMAN, Brooklyn Park, MN (US)

(72) Inventor: RACHEL ELIZABETH NIEMAN, Brooklyn Park, MN (US)

(21) Appl. No.: 19/699,730

(22) Filed: Jun. 5, 2026

Related U.S. Application Data
(63) Continuation-in-part of application No. 29/816,277, filed on Nov. 19, 2021, now abandoned.

(51) Int. Cl. A47J 19/04; B26B 11/00

(52) U.S. Cl. CPC A47J 19/04; B26B 11/006

(57) ABSTRACT

The present invention introduces a novel design for a garlic mashing tool, as detailed in the following specification and claims. This invention provides a protective sheath that can fully or partially cover a knife blade, shielding the user's hand during use. Constructed from materials such as plastic, wood, stainless steel, or a combination thereof, the device facilitates a multi-step preparation process. Users first employ the knife's cutting edge to break apart the garlic bulb. After releasing the cloves, the sheath is applied to the blade, and the clove is placed in a designated area for mashing. Pressing firmly mashes the clove and releases it from its tunic or skin. Finally, the sheath is removed so the knife can be used to chop the garlic as needed.

### CROSS-REFERENCE TO RELATED APPLICATIONS

This application is a continuation-in-part application of U.S. patent application Ser. No. 29/816,277 filed Nov. 19, 2021.

### BACKGROUND OF THE INVENTION

### 1. Field of the Invention

The present invention relates to a specialized tool for breaking garlic bulbs, removing skin or tunic from the clove, and mashing and mincing garlic cloves. It effectively fractures the garlic bulb and mashes individual cloves, which facilitates the removal of the tunic or skin and prepares the garlic for mincing while protecting your hand from the blade.

### 2. Description of Prior Art

During food preparation, it is standard practice to utilize various kitchen tools to break open garlic bulbs, peel away the skin, and subsequently mash or mince the cloves. However, relying on separate gadgets for each step is often inconvenient and consumes excessive storage space. While several patented designs—including U.S. D445,643S1, U.S. Pat. No. 6,493,946B1, U.S. D610,399S1, U.S. D539,086S1, U.S. D819,399S1 U.S. D992,380S1, US20250010505A1U.S. D561,898S1, US20160031112A1 US20200246992A1, U.S. Pat. Nos. 4,178,684A, 6,502,314B1, U.S. D255,974S, US20040231164A1 U.S. Pat. No. 7,726,030B2, U.S. D776,977S1, U.S. Pat. Nos. 12,397,455B2, 6,308,419B1, US20090223060A1 U.S. Pat. Nos. 742,703S1, 1,049,754S1, U.S. D812,435S1, U.S. Pat. No. 9,226,608B2, US20160220056A1, U.S. D610,399S1, U.S. D670,544S1, U.S. Pat. Nos. 608,604S1, 6,840,416B2, 11,850,762B1, 7,740,522B2, 931,381B2, 356,382B2, US20120159793A1, U.S. Pat. Nos. 9,889,573B2, 6,381,855B1, U.S. D790,290S1, U.S. Pat. No. 913,074S1, CN105922304A KR20250099989A, KR101985535B1, KR101538669B1, KR20130005943U KR20120008277U, EP3357380B1, CN103263231A, EP2191750A3, CN104983289A, and CN108065748A have features that do one of the steps needed to break open garlic bulbs, peel away the skin, and subsequently mash or mince the cloves, they fail to provide an all-in-one option, requiring multiple steps and tools, and are often difficult to clean, and take up space. Furthermore, using a standard Chef's knife to break open the bulb of garlic, and mash the garlic poses a safety risk of accidental cuts, and cloves frequently slide around the blade, making effective mashing difficult, and prioritizing a need for an all-in-one tool that breaks open the bulb of garlic, removes the tunic or skin from the clove, mashes the garlic, protects your hand from the blade and protects the blade from wear.

### BRIEF SUMMARY OF THE INVENTION

The present invention overcomes certain shortcomings as mentioned above. In addition my invention offers a sleek and compact design, functionality because it can be used as a multi-tool for prepping Garlic, and a protective sheath for your knife, and as shown in FIG. 1-42. And whether the present invention is used to partially cover the blade of the knife, as shown in 1, FIG. 7, FIG. 17, or fully cover the blade as shown in FIG. 23, FIG. 30, and FIG. 36 or use it without a knife entirely. The main purpose of my invention is to use for breaking garlic bulbs, removing the skin from the clove and mashing it while protecting your hand and blade, but it is not limited to such use.

### BRIEF DESCRIPTION OF SEVERAL VIEWS OF THE DRAWING

FIG. 1. is a Perspective view of the Knife Sleeve Garlic Masher showing my new invention; the knife is shown for illustrative purposes only.

FIG. 2. is a Right Perspective view of my new invention shown in FIG. 1;

FIG. 3. is a Top view of my new invention shown in FIG. 1; The bottom view is a mirror image of the top view;

FIG. 4. is a Front view of my new invention shown in FIG. 1;

FIG. 5. is a back view of my new invention shown in FIG. 1;

FIG. 6. is a Side view of my new invention shown in FIG. 1; The other side view is a mirror image;

FIG. 7. is a Perspective view of the Knife Sleeve Garlic Masher showing my new invention; the knife is shown for illustrative purposes only.

FIG. 8. is a Right Perspective view of my new invention shown in FIG. 7;

FIG. 9. is a Top view of my new invention shown in FIG. 7; The bottom view is a mirror image of the top view;

FIG. 10. is a Front view of my new invention shown in FIG. 7;

FIG. 11. is a back view of my new invention shown in FIG. 7;

FIG. 12. is a Side view of my new invention shown in FIG. 7; The other side view is a mirror image;

FIG. 13. is a Right Perspective view of my new invention shown in FIG. 7; showing optional Internal Gripping Features;

FIG. 14. Is a section view of my new invention shown in FIG. 7; showing optional Internal Gripping Features;

FIG. 15. Is another section view of my new invention shown in FIG. 7; showing optional Internal Gripping Features;

FIG. 16. Is a side view of my new invention shown in FIG. 7; showing optional Internal Gripping Features;

FIG. 17. is a Perspective view of the Knife Sleeve Garlic Masher showing my new invention; the knife is shown for illustrative purposes only.

FIG 18. is a right perspective view of my new invention shown in FIG. 17;

FIG. 19. is a Top view of my new invention shown in FIG. 17; The bottom view is a mirror image of the top view;

FIG. 20. is a Front view of my new invention shown in FIG. 17;

FIG. 21. is a back view of my new invention shown in FIG. 17;

FIG. 22. is a Side view of my new invention shown in FIG. 17; The other side view is a mirror image;

FIG. 23. is a Perspective view of the Knife Sleeve Garlic Masher showing my new invention; the knife is shown for illustrative purposes only.

FIG. 24. is a Right Perspective view of my new invention shown in FIG. 23;

FIG. 25. is a Top view of my new invention shown in FIG. 23;

FIG. 26. is a Bottom view of my new invention shown in FIG. 23;

FIG. 27. is a Front view of my new invention shown in FIG. 23;

FIG. 28. is a Side view of my new invention shown in FIG. 23;

FIG. 29. Is another side view of my new invention shown in FIG. 23;

FIG. 30. is a Perspective view of the Knife Sleeve Garlic Masher showing my new invention; the knife is shown for illustrative purposes only.

FIG. 31. is a Right Perspective view of my new invention shown in FIG. 30;

FIG. 32. is a Top view of my new invention shown in FIG. 30;

FIG. 33. is a Bottom view of my new invention shown in FIG. 30;

FIG. 34. is a Front view of my new invention shown in FIG. 30;

FIG. 35. is a Side view of my new invention shown in FIG. 30; The other side view is a mirror image;

FIG. 36. is a Perspective view of the Knife Sleeve Garlic Masher showing my new invention; the knife is shown for illustrative purposes only.

FIG. 37. is a Right Perspective view of my new invention shown in FIG. 36;

FIG. 38. is a Top view of my new invention shown in FIG. 36;

FIG. 39. is a Bottom view of my new invention shown in FIG. 36;

FIG. 40. is a side view of my new invention shown in FIG. 36;

FIG. 41. is another side view of my new invention shown in FIG. 36;

FIG. 42. is a front view of my new invention shown in FIG. 36.

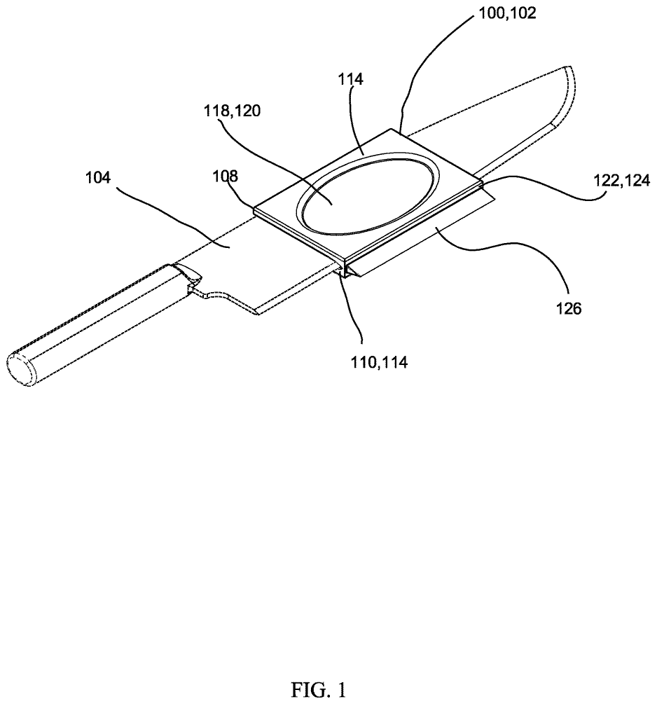

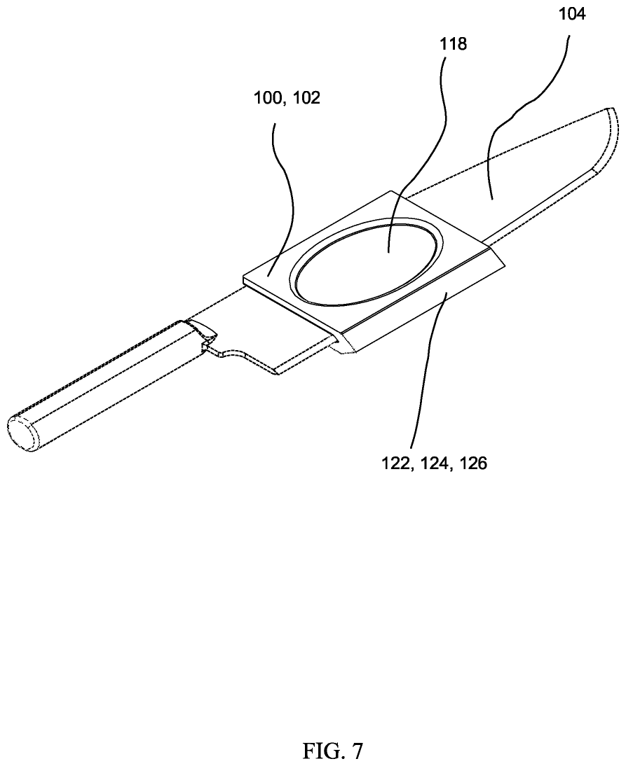

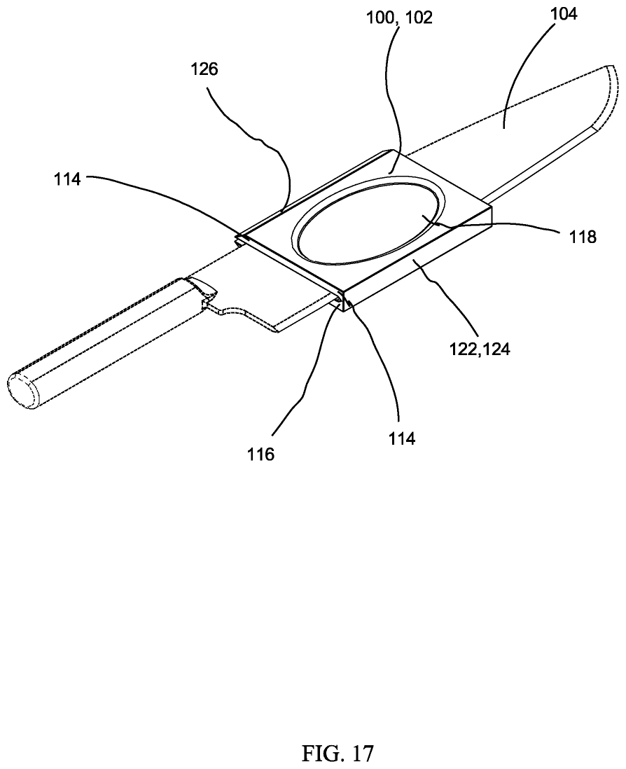

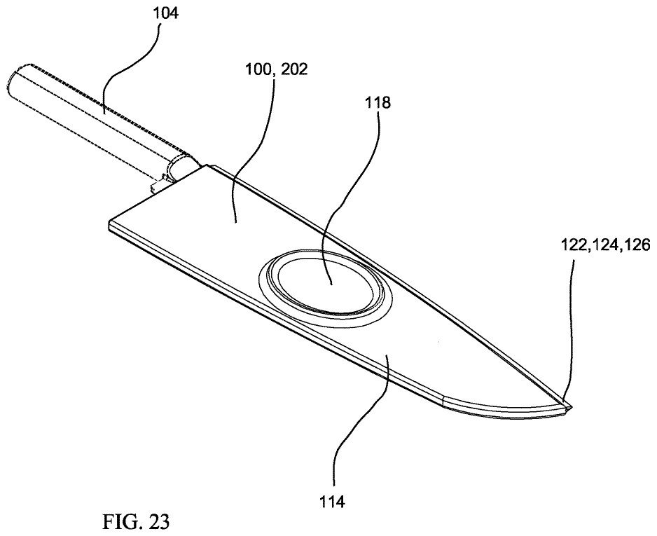

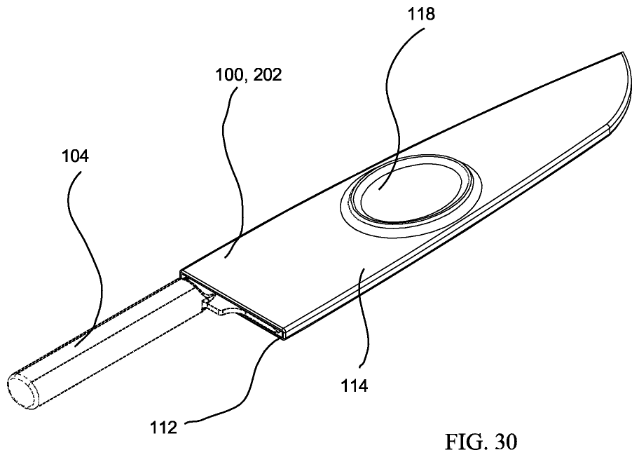

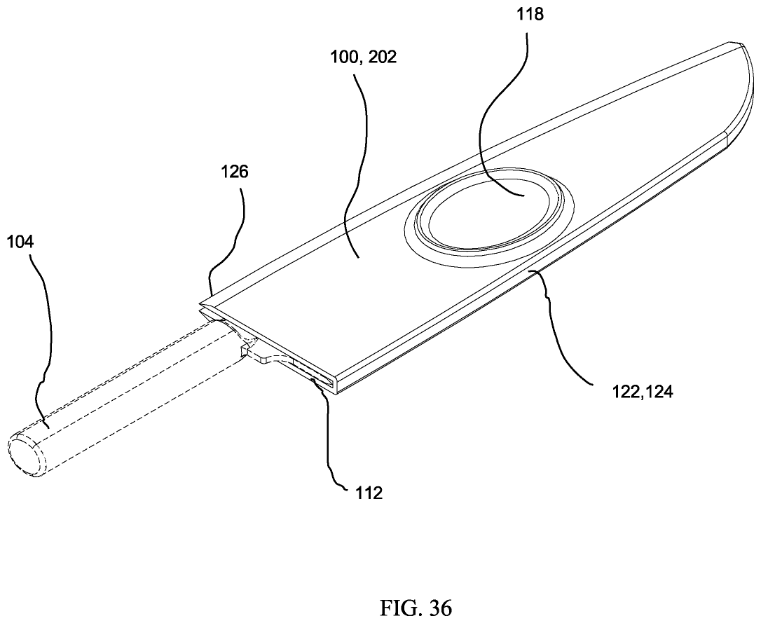

The broken lines in the FIG. 1, FIG. 7, FIG. 17, FIG. 23, FIG. 30 and FIG. 36 are for illustrative purposes to show how the invention can be used only and form no part of the claimed design.

### DETAILED DESCRIPTION OF PREFERRED EMBODIMENTS

### First Embodiment (Primary)

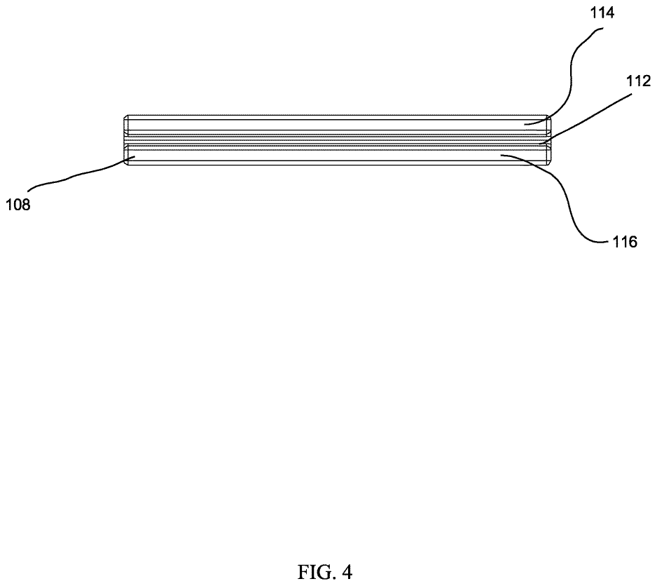

Sheath Structure and Knife Blade Interface Referring collectively to the perspective, plan, and elevational views of FIG. 1 through FIG. 6, the device comprises a main body (100) configured as a profiled sheath body (102). As best illustrated in the perspective view of FIG. 1, the profiled sheath body (102) is structurally configured to fit over, slide onto, or receive an existing blade of an external cutting tool, such as a knife blade (104) (shown for illustrative purposes).

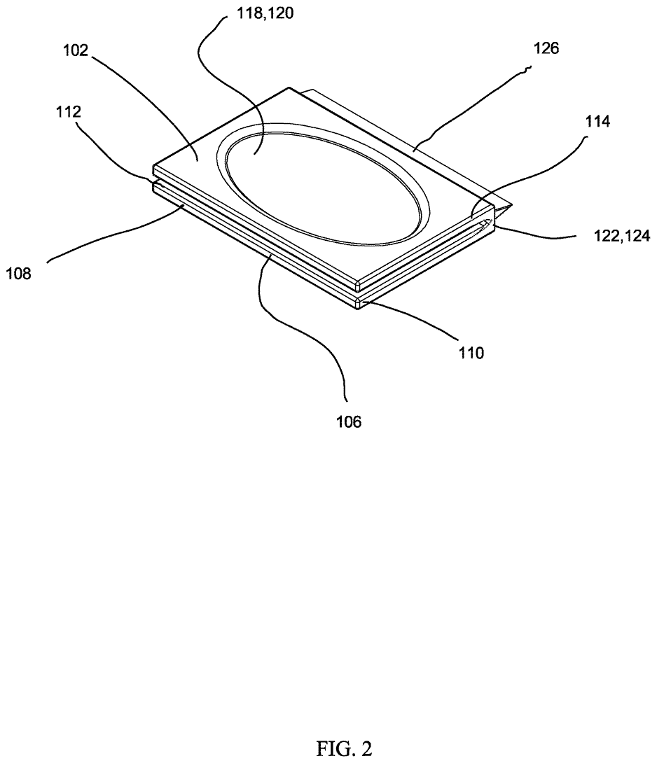

To facilitate this interface, the profiled sheath body (102) is substantially open on three distinct sides, as shown across the views of FIGS. 1, 2, 4, and 6. Specifically, the profiled sheath body (102) features an open front end (106) (visible in FIGS. 2, 4, and 6), an open lower edge (108) (visible in FIGS. 1, 4, 5, and 6), and an open terminal end (110), which collectively define an internal channel (112) to removably, adjustably, or permanently house the knife blade (104).

To secure the profiled sheath body (102) to the knife blade (104), the internal channel (112) is configured for selective, releasable engagement with the blade. It is explicitly contemplated that the profiled sheath body (102) may matingly interface with the knife blade (104) via a sliding friction fit, a positive snap-fit engagement, a mechanical locking mechanism, or a combination thereof.

Materials of Construction The components of the device, including the main body (100) and profiled sheath body (102), may be fabricated from a wide variety of structurally suitable materials. Without limitation, the device may be formed of polymers (e.g., plastic), metallic materials (e.g., stainless steel, aluminum), organic materials (e.g., wood, bamboo), or any multi-material combination, composite, or alloy thereof. Different portions of the device may be formed of different materials to optimize structural rigidity, weight, and gripping capability.

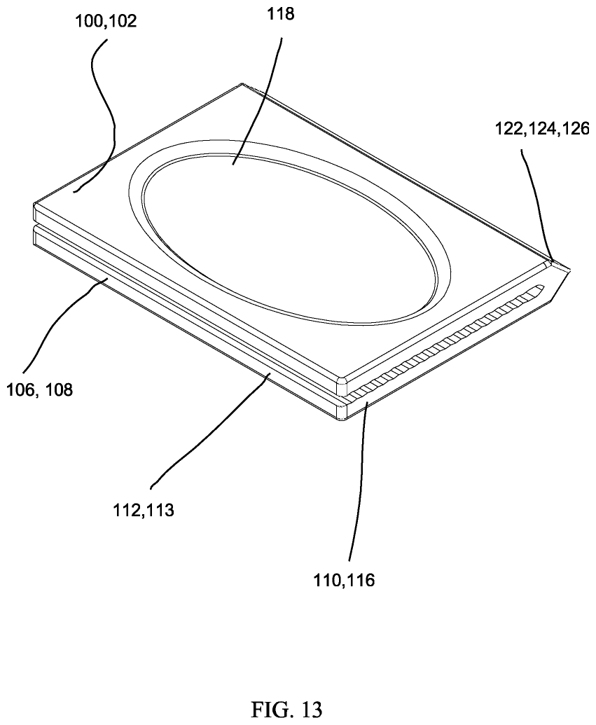

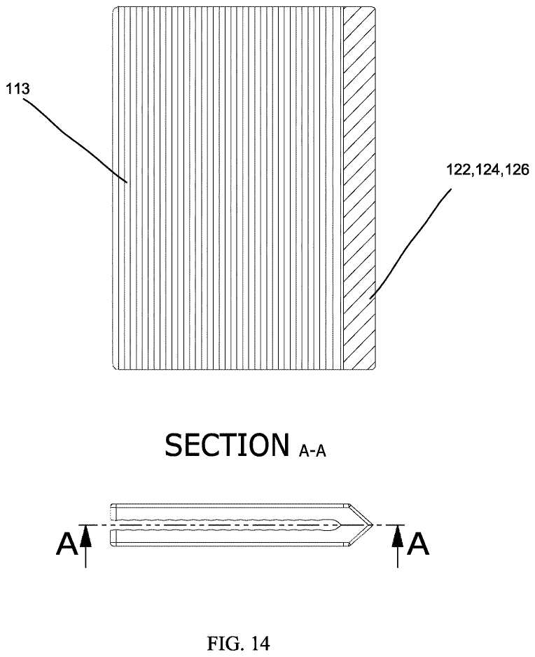

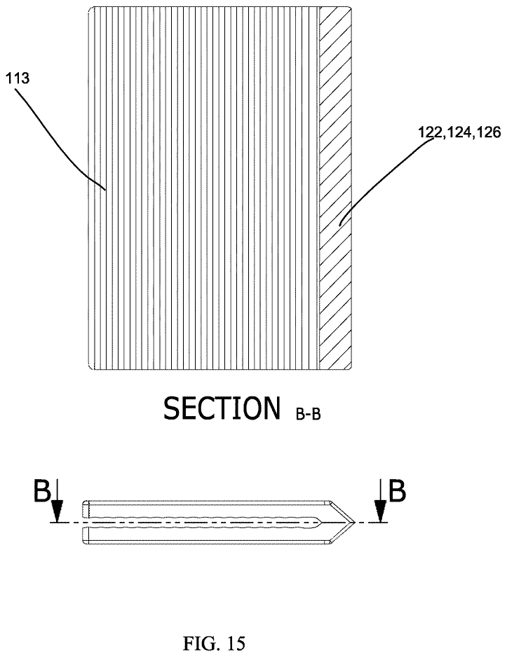

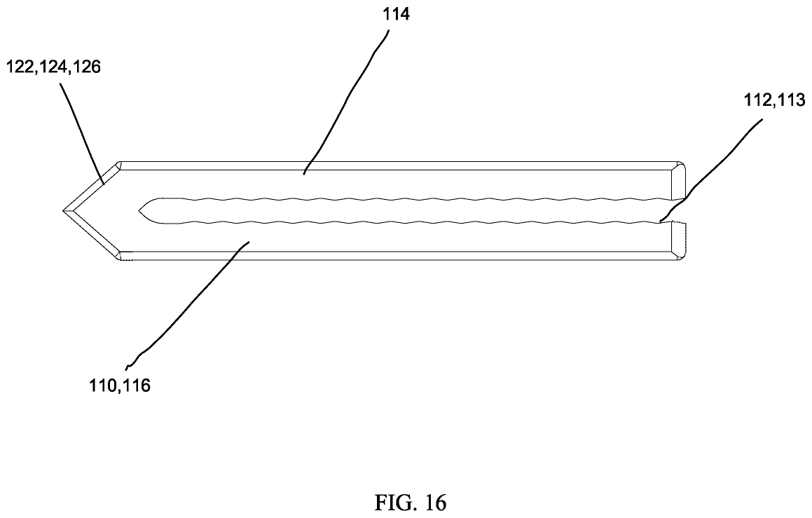

Internal Gripping Features To enhance stability and prevent unwanted displacement during operation, the interior surfaces defining the internal channel (112) (accessible via the views in FIG. 13 through FIG. 16) may optionally include a plurality of blade-engaging retention features (113). In one embodiment, these retention features (113) comprise a series of raised ridges, projecting teeth, serrations, or high-friction gripping elements configured to establish a localized frictional interference fit against the planar surfaces of the knife blade (104). It is explicitly contemplated that the blade-engaging retention features (113) may comprise various materials of construction, which may be identical to the material composition comprising the main body (100), or may alternatively be formed of a distinct, diverse, or multi-material composite material configuration relative to the main body (100) to selectively alter the local coefficient of friction or compliance. However, the internal channel (112) is not limited to such structures and may alternatively feature entirely smooth, unobstructed, or uniformly continuous interior walls.

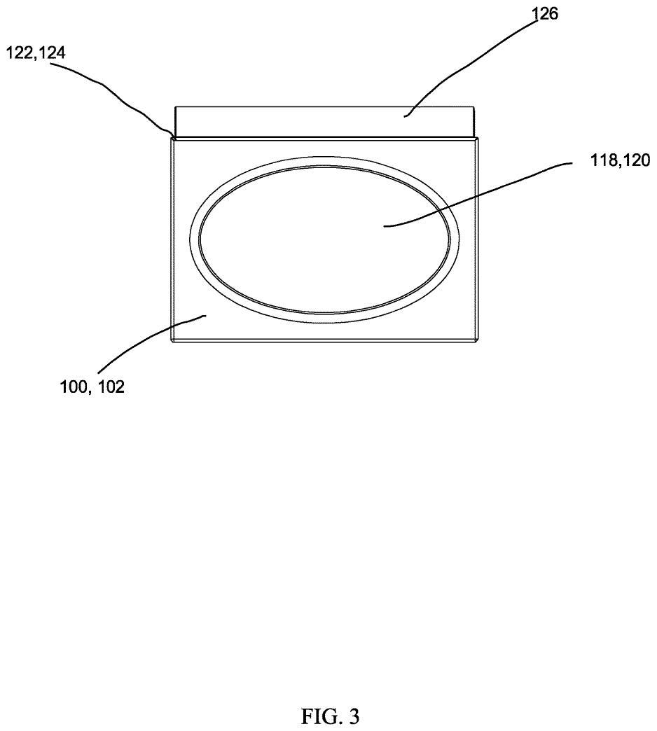

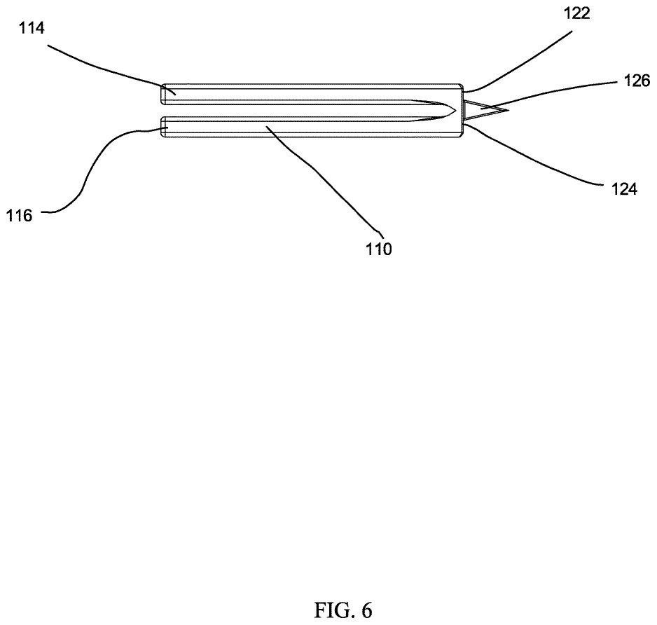

Opposing Co-Axial Indentations As illustrated in FIG. 1 and the isolated perspective view of FIG. 2, and as further shown from the top profile of FIG. 3 and side profile of FIG. 6, the profiled sheath body (102) includes a first lateral wall (114) and an opposing second lateral wall (116). The first lateral wall (114) features at least one first recessed indentation (118). The second lateral wall (116) features at least one second recessed indentation (120). As structurally demonstrated by the alignment across FIG. 3 (top view, the bottom view being a mirror image) and FIG. 6 (side view, the other side view being a mirror image), the first recessed indentation (118) and the second recessed indentation (120) are aligned substantially directly opposite one another across the width of the profiled sheath body (102).

In a primary embodiment, the indentations (118, 120) share a common central axis, establishing a mirrored, co-axial relationship configured to optimize a pinching or force applied to an organic object by a user's opposing digits. The geometric profiles of the first (118) and second (120) recessed indentations may independently comprise an oval, circular, square, rectangular, polygonal, ergonomic, or irregular geometric profile. The external surfaces of the first lateral wall (114) and the second lateral wall (116)—including the localized areas within and surrounding the indentations (118, 120) shown in FIG. 1 through FIG. 3—may comprise a substantially smooth, uniform, contoured, or irregular surface finish corresponding to the external geometry of the device.

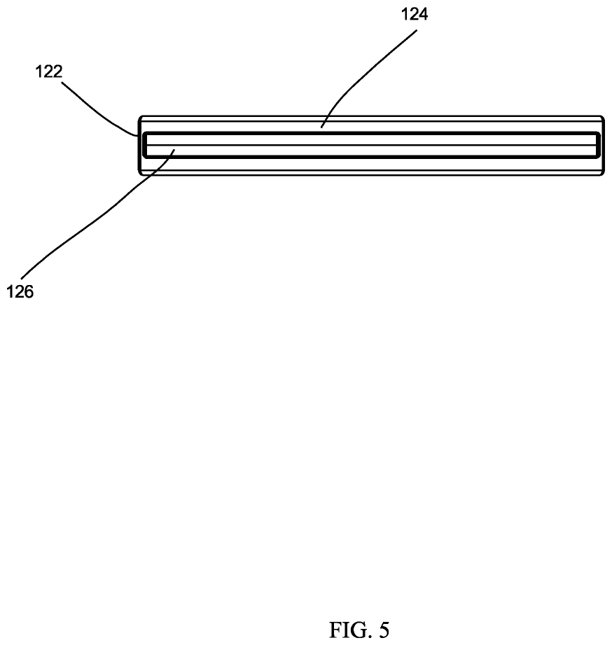

Rear Impact Edge and Variable Protrusion Profile Referring now to the upper portion of the device as seen from the perspective views of FIGS. 1 and 2, the top view of FIG. 3, the elevational view of FIG. 5, and the side view of FIG. 6, the profiled sheath body (102) defines a back end (122) featuring a generally long longitudinal edge (124). Positioned along, integrated with, or protruding from this long longitudinal edge (124) is a distinct, sharp structural edge (126) configured to concentrate mechanical or impact force for tasks such as breaking, fracturing, crushing, or opening a garlic pod or other organic and inorganic objects against an external workspace.

As visible from the back profile (FIG. 5), and the side profile (FIG. 6), the precise geometric bounds, origin, and scale of the sharp structural edge (126) are explicitly variable. The sharp structural edge (126) is not limited to starting its upward protrusion from all specific corners or vertices of the long longitudinal edge (124). The protrusion may originate from any localized point, vertex, midpoint, or region along the back end (122), and may extend upwardly therefrom.

Furthermore, as illustrated by the spanning length shown in FIGS. 1, 2, 3, 5 and 6, the sharp structural edge (126) features an open, scalable dimension; it may comprise a relatively long profile or a short profile along the longitudinal edge (124), and does not feature a single, distinct, or restrictive dimensional size, height, thickness, or width. It is explicitly contemplated that the sharp structural edge (126) may be continuously or discontinuously formed along the back end (122).

### Second Embodiment

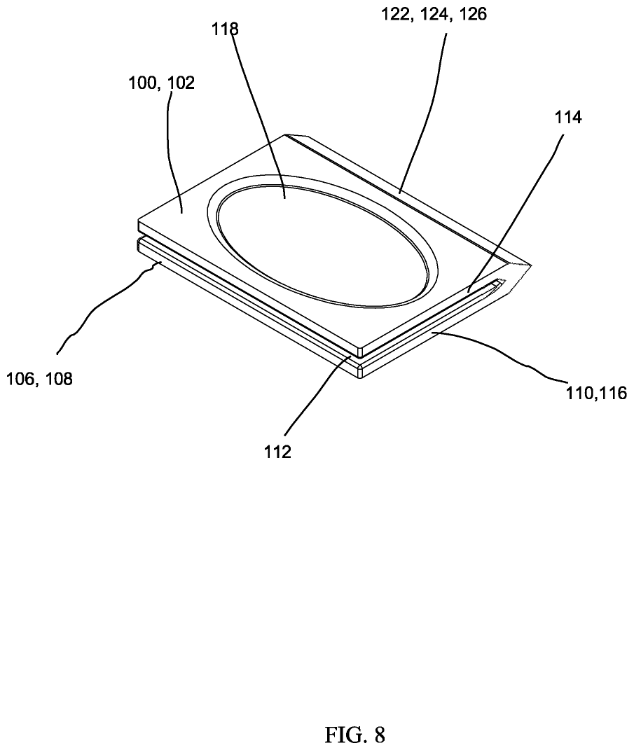

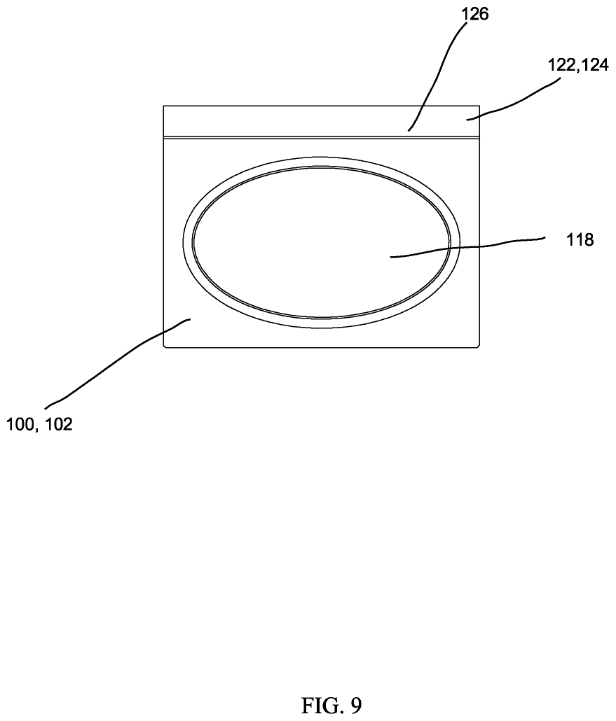

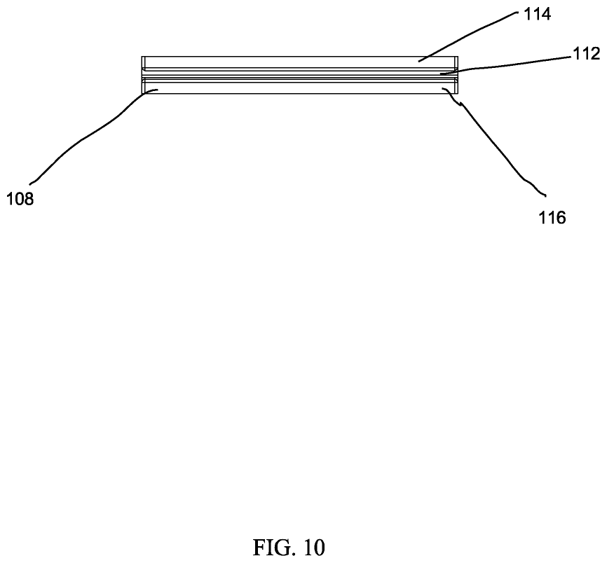

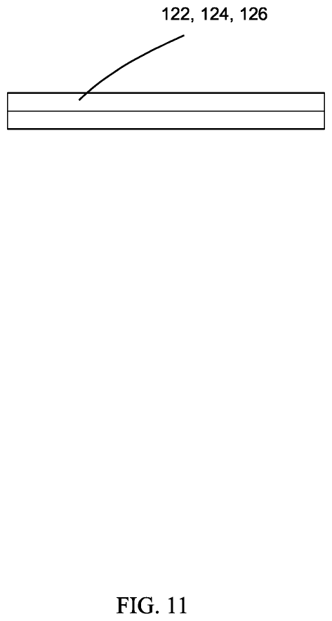

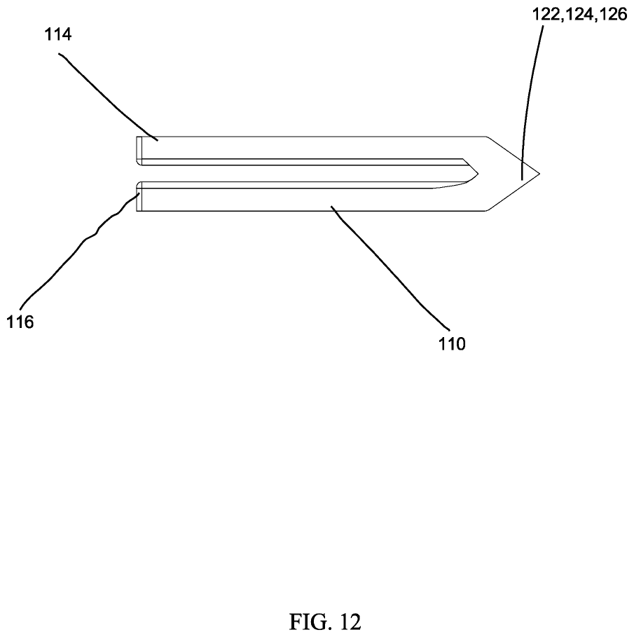

General Structural Configuration Referring now to an alternative configuration of the device, a second embodiment is disclosed. The second embodiment retains substantially all of the structural, functional, geometric, and material characteristics of the primary embodiment described above-including the generally profiled sheath body (102), the three open sides (106, 108, 110), the internal channel (112), and the opposing co-axial indentations (118, 120) as shown across FIG. 7 through FIG. 16.

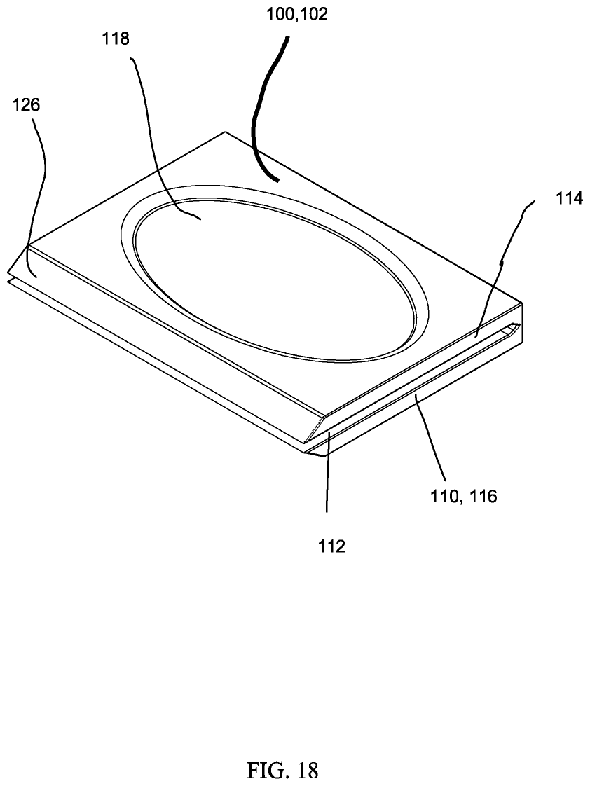

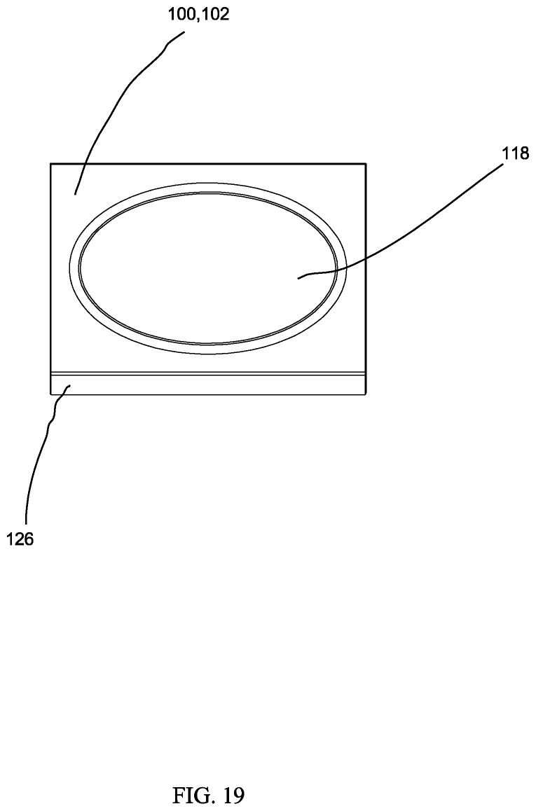

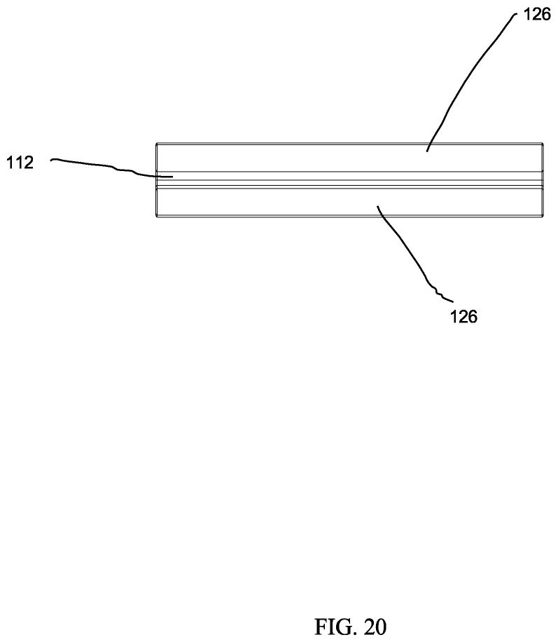

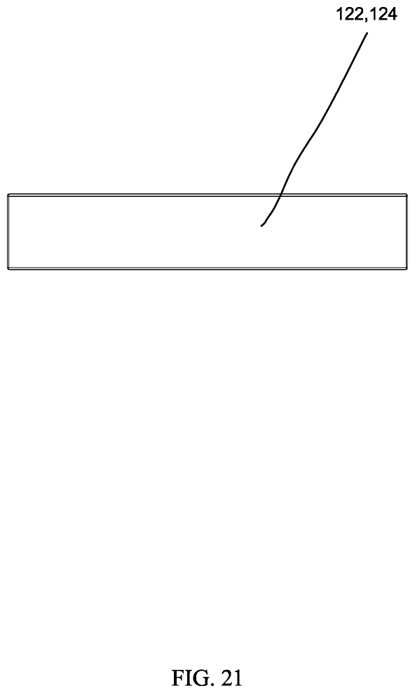

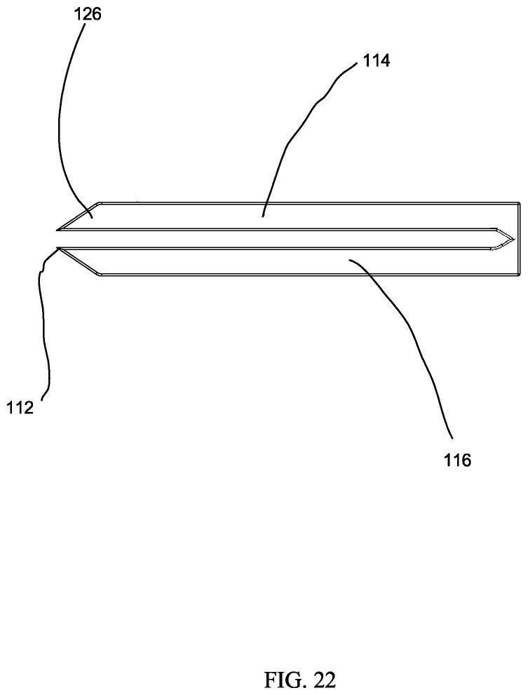

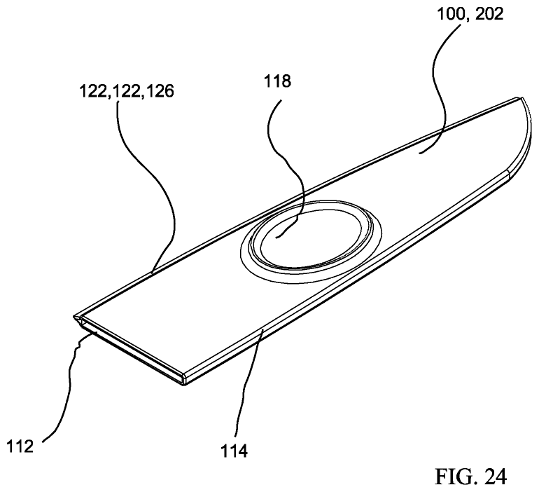

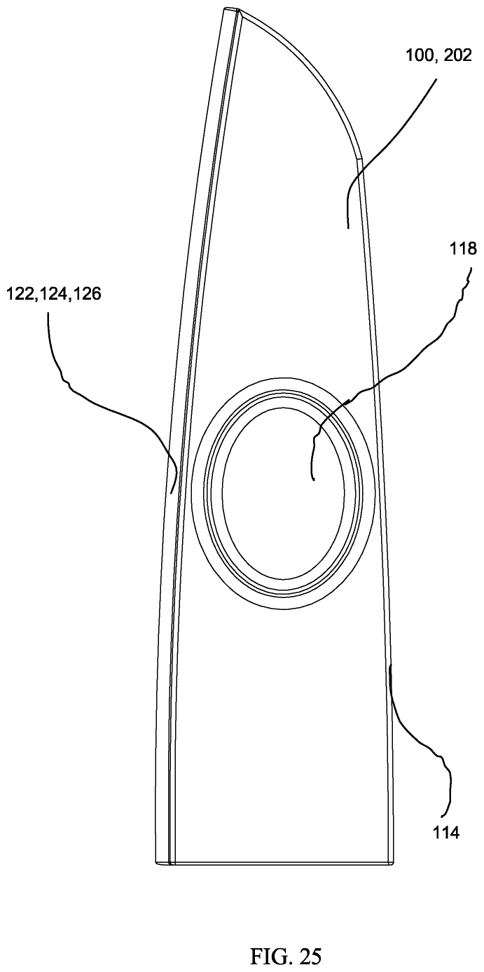

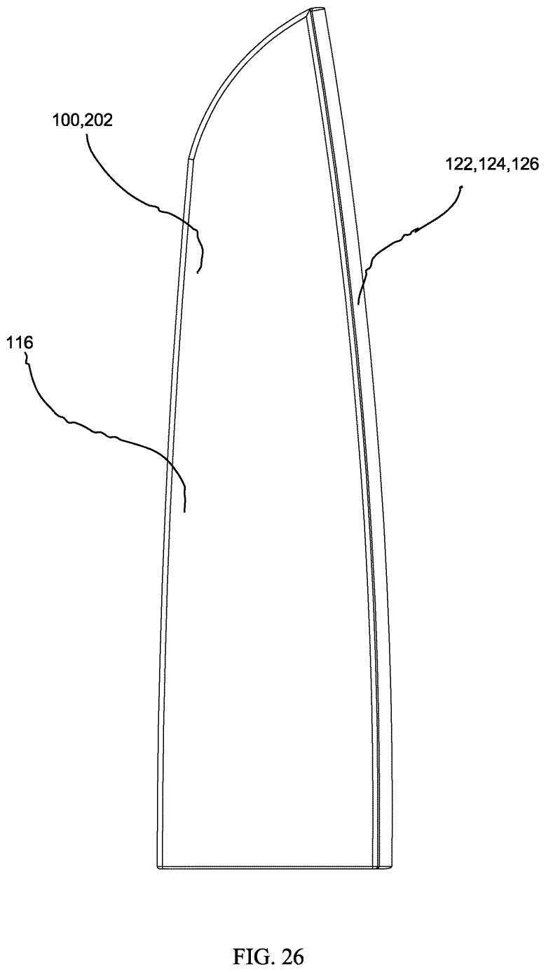

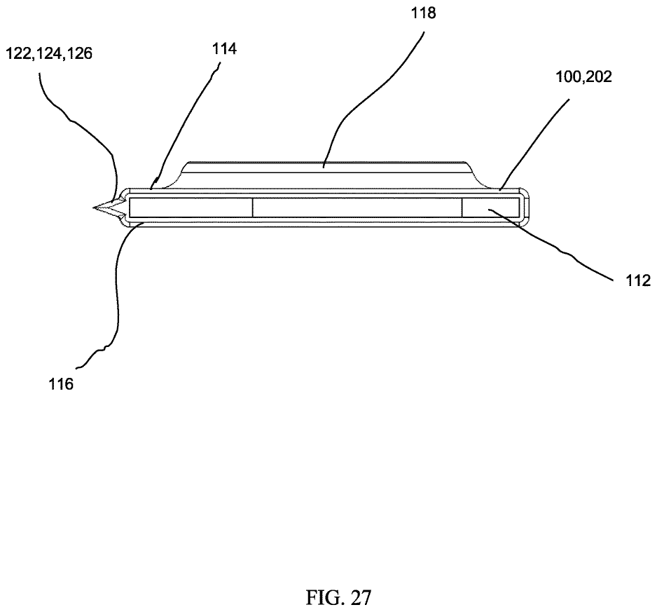

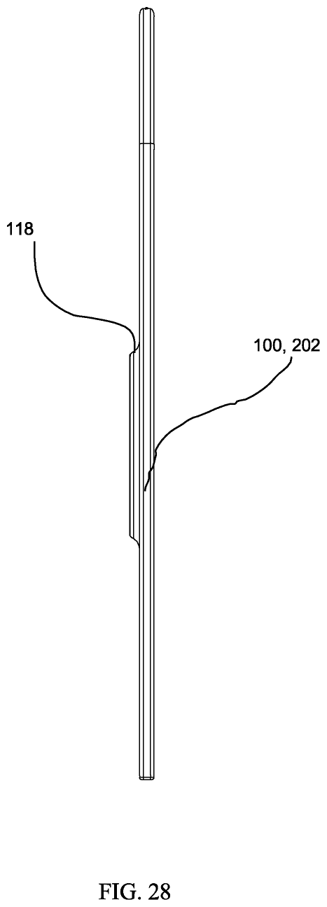

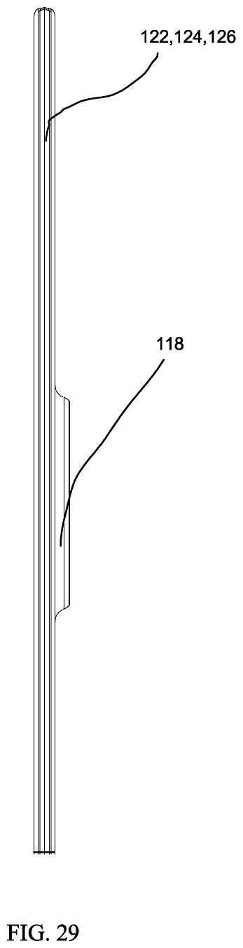

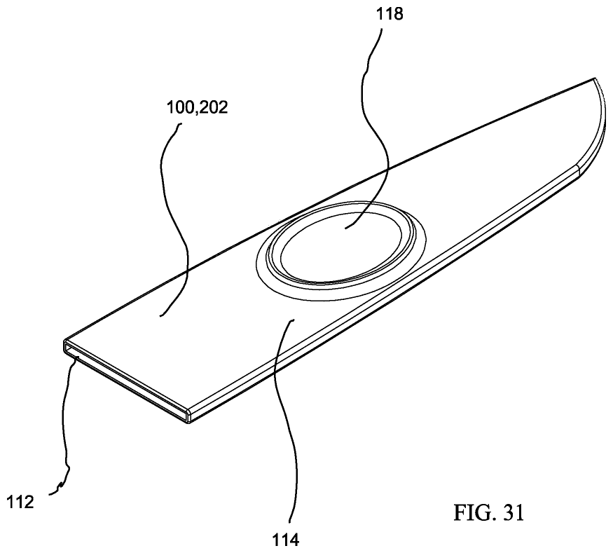

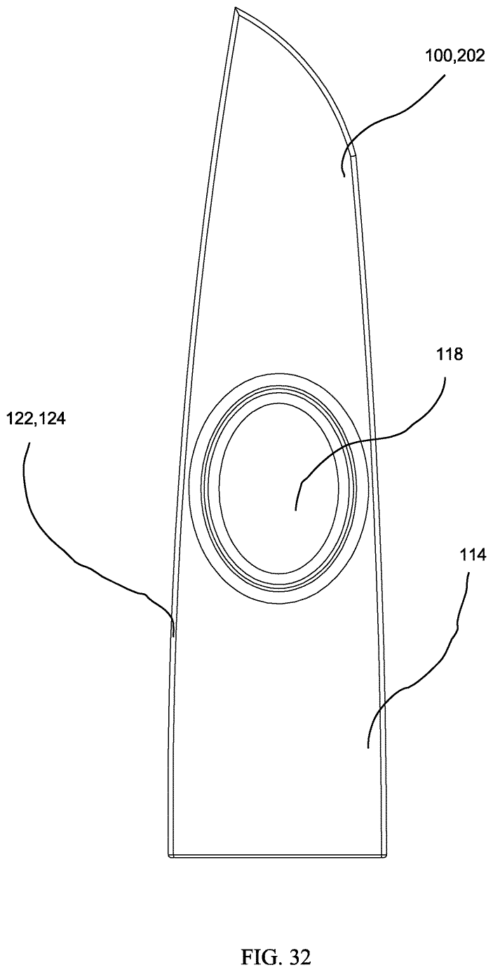

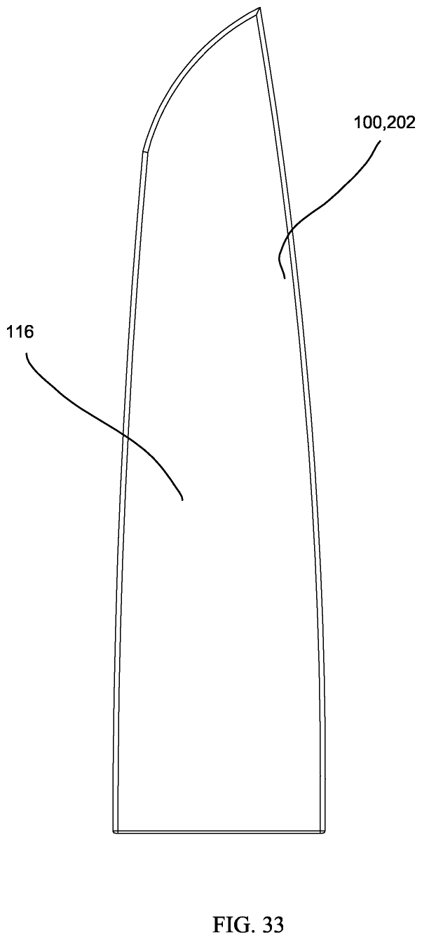

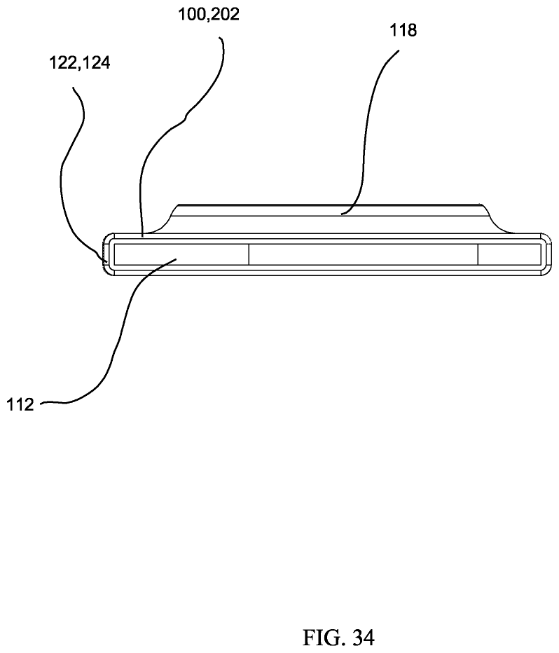

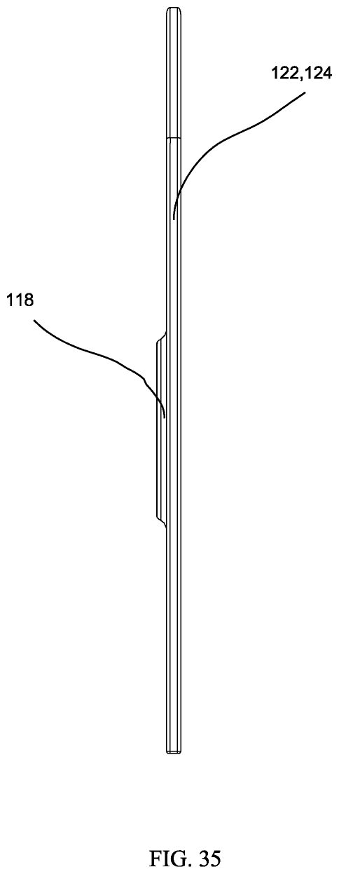

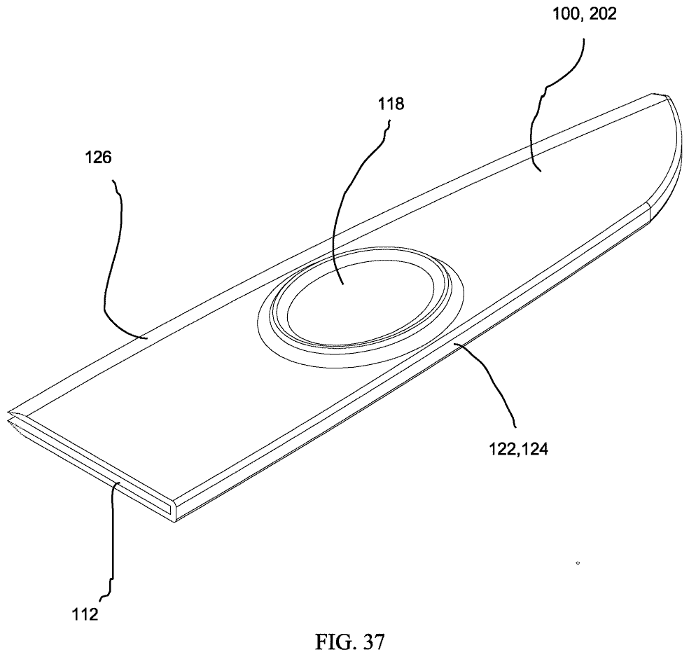

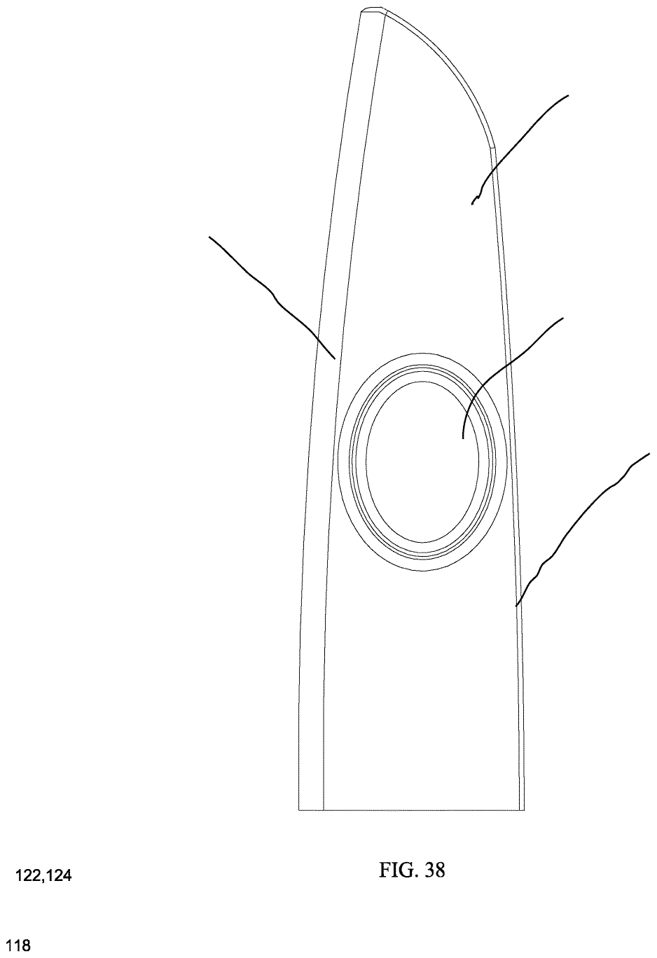

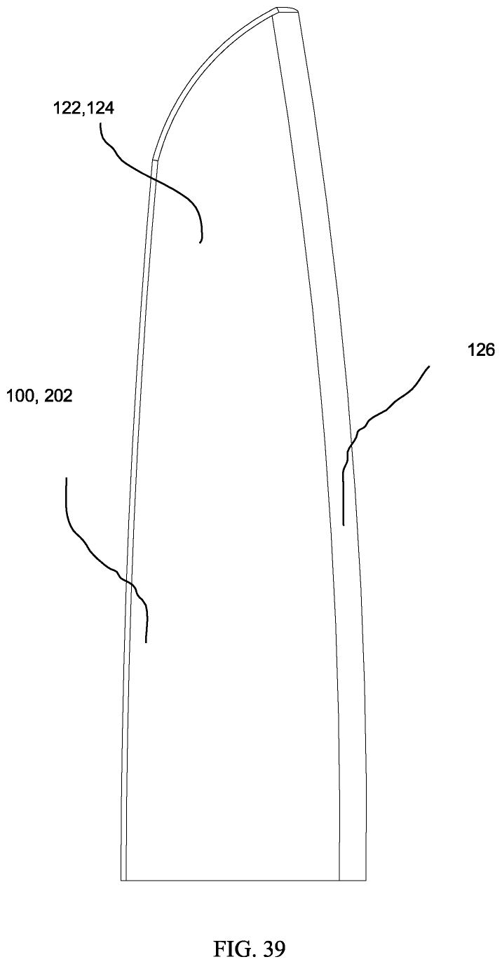

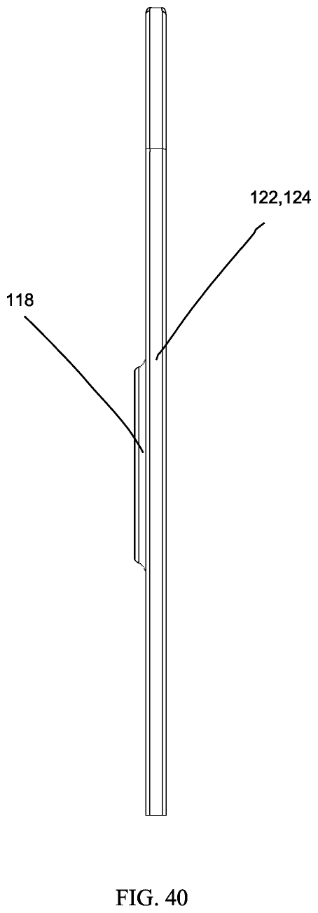

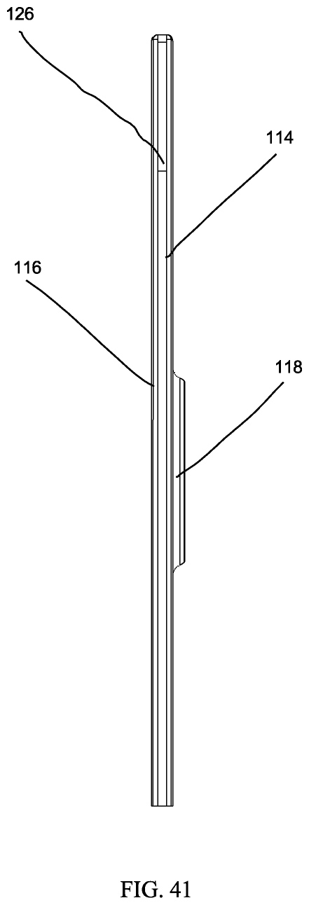

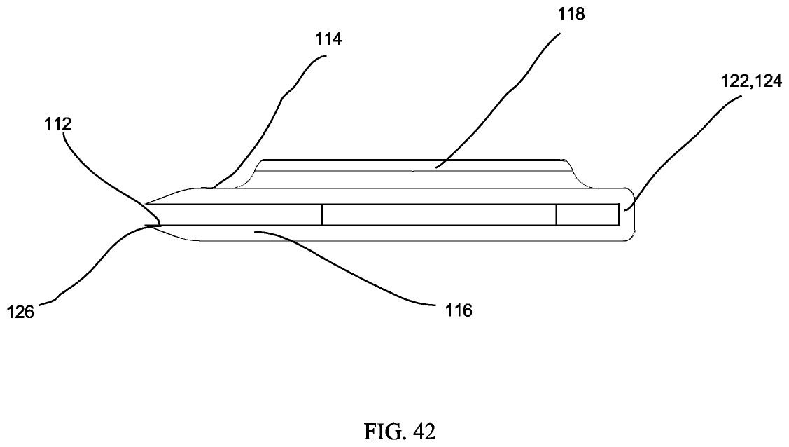

As illustrated specifically in the embodiment of FIG. 13 to FIG. 16, the interior walls defining the internal channel (112) may integrate a plurality of blade-engaging retention features (113), which may comprise material compositions identical to or distinct from the main body (100). It is explicitly contemplated that this feature is optional and may be incorporated into any of the other embodiments described herein (e.g., the embodiments of FIGS. 1-42) without departing from the scope of the present disclosure. The structural variations unique to the second embodiment are detailed below.

Fully Extruded Continuous Impact Edge Configuration In the second embodiment, the upper portion of the device defining the back end (122) and its long longitudinal edge (124) is structurally modified to maximize the linear surface area available for striking or pressing actions. Specifically, the distinct, sharp structural edge (126) comprises a single, uninterrupted, fully extruded edge.

Rather than originating from a localized midpoint or comprising a selectively scaled or shortened profile, the sharp structural edge (126) extends continuously and seamlessly along the entirety of the long longitudinal edge (124) from the front boundary adjacent to the open front end (106) to the rear boundary adjacent to the open terminal end (110). This fully extruded, continuous configuration ensures that a uniform mechanical or impact force is concentrated across the complete overhead span of the profiled sheath body (102), allowing a user to reliably fracture, crush, or open an object regardless of where impact contact is initiated along the upper boundary of the device.

### Third Embodiment

General Structural Configuration Referring now to another alternative configuration of the device, a third embodiment is disclosed. The third embodiment retains substantially all of the structural, functional, geometric, and material characteristics of the primary embodiment described above—including the generally profiled sheath body (102), the three open sides (106, 108, 110), the internal channel (112) with optional internal retention features (113) of identical or distinct material composition, and the opposing co-axial indentations (118, 120). The structural variations unique to the third embodiment are detailed below, and shown across FIG. 17 through FIG. 22.

Relocated and Flattened Back End Profile In the third embodiment, the back end (122) defining the long longitudinal edge (124) is structurally modified such that the distinct, upwardly protruding sharp structural edge (126) of the primary embodiment is omitted from this location. Instead, the back end (122) and its long longitudinal edge (124) may comprise a substantially flat, planar, or smoothed surface profile. However, the back end (122) is not strictly limited to a flat profile and may alternatively feature a contoured, curved, or irregular geometry without a sharp apex. This flattened or smoothed longitudinal edge (124) provides a comfortable, unobstructed surface for a user to apply manual downward pressure during alternative operational modes.

Relocated Structural Impact Edge To retain the mechanical crushing and fracturing functionality of the device, the distinct, sharp structural edge (126) is relocated to an alternative position on the main body (100). Specifically, the sharp structural edge (126) is positioned on, integrated with, or protrudes outwardly from the forward portion of the device adjacent to the open front end (106).

It is explicitly contemplated that the relocated sharp structural edge (126) may be positioned on either one or both of the external lateral sides of the device. Specifically, the sharp structural edge (126) may protrude from the external surface of the first lateral wall (114), the external surface of the second lateral wall (116), or symmetrically from both the first and second lateral walls (114, 116) in close proximity to the perimeter of the open front end (106). When relocated to this forward lateral position, the sharp structural edge (126) remains structurally configured to concentrate mechanical or impact force against an external workspace.

### Fourth Embodiment

General Structural Configuration Referring now to another alternative configuration of the device, a fourth embodiment is disclosed. The fourth embodiment retains substantially all of the material compositions, internal features, and surface functionalities of the primary embodiment described above—including the optional internal retention features (113) of identical or distinct material composition, the opposing co-axial indentations (118, 120), and the rear impact edge with a variable protrusion profile (122, 124, 126) positioned along the upper portion of the device. The structural variations unique to the fourth embodiment are detailed below, and shown across FIG. 23 through FIG. 29.

Substantial Enclosure and Full Blade Sheath Configuration In the fourth embodiment, the main body (100) is modified from a partial cover to a substantially enclosed, full-cover profiled sheath (202). To effectuate this configuration, the open configuration of the front end and the lower edge as described in the primary embodiment are omitted and replaced by closed structural boundaries. Specifically, the full-cover profiled sheath (202) features a closed front end and a closed lower edge, which, together with the irregular or asymmetrical geometry of the lateral walls (114, 116), transition the internal channel (112) into a substantially enclosed, protective internal pocket.

Modified Opening and Insertion Interface The full-cover profiled sheath (202) features an open terminal end (110) configured to receive the longitudinal sliding insertion of the knife blade (104) into the protective internal pocket. However, the opening configuration and the protective coverage of the full-cover profiled sheath (202) are explicitly variable and not structurally restricted to a single permutation:
Plurality of Openings: One or more auxiliary openings, access slits, or clearing apertures may be formed through any of the closed boundaries (such as the closed front end or closed lower edge) to facilitate debris removal or drainage.
Variable Spatial Exposure: The dimensions of the protective internal pocket may be selectively scaled to allow a portion of the knife blade (104)—such as a portion of the spine, choil, or tip—to remain exposed or visible through the irregular sheath structure.

### Fifth Embodiment

General Structural Configuration Referring now to another alternative configuration of the device, a fifth embodiment is disclosed. The fifth embodiment comprises a single-piece, unitary structural configuration that retains substantially all of the material compositions, internal features, and surface functionalities of the preceding embodiments described above—including the single-piece main body (100), the profiled sheath body (102), the internal channel (112) with optional internal retention features (113) of identical or distinct material composition, and the opposing co-axial indentations (118, 120). The structural variations unique to the fifth embodiment are detailed below, and shown across FIG. 30 through FIG. 35.

Complete Omission of Protruding Impact Edge and Closed Back End Profile In the fifth embodiment, the distinct, upwardly protruding sharp structural edge (126) described in alternative configurations is entirely omitted from all locations on the device. The upper portion of the device defining the back end (122) and its long longitudinal edge (124) comprises a completely solid, closed structural boundary.

To provide a sleek and safe exterior geometry, the closed long longitudinal edge (124) features a substantially flat, planar, or smoothed surface profile, or an asymmetrical, contoured, radiused, or curved geometry without a sharp apex. This closed, continuous upper ceiling provides a comfortable, unobstructed zone for a user to safely apply manual downward pressure with a hand or digit during alternative operational modes while presenting a streamlined profile optimized purely for blade protection and standard compression tasks.

### Sixth Embodiment

General Structural Configuration Referring now to another alternative configuration of the device, a sixth embodiment is disclosed. The sixth embodiment comprises a single-piece, unitary structural configuration that retains substantially all of the material compositions, internal features, and surface functionalities of the preceding embodiments described above—including the single-piece main body (100), the profiled sheath body (102), the internal channel (112) with optional internal retention features (113) of identical or distinct material composition, and the opposing co-axial indentations (118, 120). The structural variations unique to the fifth embodiment are detailed below, and shown across FIG. 36 through FIG. 42.

Omission of Protruding Rear Impact Edge and Relocated Structural Impact Edge In the sixth embodiment, the upper portion of the device defining the back end (122) and its long longitudinal edge (124) is structurally modified such that the distinct, upwardly protruding sharp structural edge (126) of the primary embodiment is omitted from this location.

To retain the mechanical crushing and fracturing functionality of the device, the distinct, sharp structural edge (126) is relocated to an alternative position on the main body (100) similar to the configuration described in the third embodiment. Specifically, the sharp structural edge (126) is positioned on, integrated with, or protrudes outwardly from the forward portion of the device adjacent to the open front end (106). It is explicitly contemplated that the relocated sharp structural edge (126) may protrude from the external surface of the first lateral wall (114), the external surface of the second lateral wall (116), or symmetrically from both the first and second lateral walls (114, 116) in close proximity to the perimeter of the open front end (106), remaining structurally configured to concentrate mechanical or impact force against an external workspace.

Open Back End and Top-loading Channel Permutation Furthermore, while the sharp structural edge (126) is omitted from the upper boundary, the back end (122) and the long longitudinal edge (124) of this single-piece configuration feature an open design. The long longitudinal edge (124) defines a continuous or discontinuous longitudinal slot, access slit, or open-top channel that communicates directly with the internal channel (112).

Respective of the irregular external profile of the device, this open-top configuration is structurally configured to allow the knife blade (104) to slide vertically, angularly, or longitudinally into the main body (100), or pass through and remain vertically or longitudinally exposed through the upper boundary of the profiled sheath body (102). This configuration safely accommodates exceptionally tall, thick, or non-standard blade geometries while maintaining the forward-positioned impact mechanics and the single-piece integrity of the first lateral wall (114) and second lateral wall (116).

Broadening Boilerplate Text The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comproving,” when used in this specification, specify the presence of stated features, integers, steps, operations, elements, and/or components, but do not preclude the presence or addition of one or more other features, integers, steps, operations, elements, components, and/or groups thereof.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

The claimed invention is:

1. An attachment device for a knife blade, comprising: a main body comprising a sheath structure defining an internal channel configured to removably receive at least a portion of a knife blade; the main body further comprising a first lateral wall and an opposing second lateral wall defining opposite lateral boundaries of the internal channel; wherein the first lateral wall comprises at least one first recessed indentation on an external surface thereof; and wherein the second lateral wall comprises at least one second recessed indentation on an external surface thereof, the at least one second recessed indentation being aligned substantially opposite the at least one first recessed indentation to define a co-axial pair of finger-gripping indentations configured to receive an opposing pinching force applied by a user's digits.

2. The device of claim 1, wherein the internal channel is open on three sides comprising an open front end, an open lower edge, and an open terminal end.

3. The device of claim 1, wherein the internal channel is defined by a closed front end and a closed lower edge to form a substantially enclosed protective pocket, and an open terminal end configured to longitudinally receive the knife blade.

4. The device of claim 1, wherein the internal channel communicates with an open longitudinal slot extending along a top longitudinal edge of the main body, configured to allow a portion of the knife blade to pass vertically therethrough.

5. The device of claim 1, further comprising at least one sharp structural edge protruding outwardly from an external surface of the main body, the sharp structural edge configured to concentrate mechanical impact force against an external object.

6. The device of claim 5, wherein the sharp structural edge is positioned along a top longitudinal edge of the main body.

7. The device of claim 6, wherein the sharp structural edge extends continuously along an entirety of the top longitudinal edge from a front boundary to a rear boundary of the main body.

8. The device of claim 5, wherein the sharp structural edge is positioned adjacent to a front end of the main body.

9. The device of claim 8, wherein the sharp structural edge comprises a first edge protruding from the external surface of the first lateral wall and a second edge protruding from the external surface of the second lateral wall.

10. The device of claim 1, wherein a top longitudinal edge of the main body comprises a substantially flat, planar surface profile configured to receive downward manual pressure.

11. The device of claim 1, wherein the internal channel comprises a plurality of interior walls including a plurality of blade-engaging retention features configured to establish a localized frictional interference fit against the knife blade.

12. The device of claim 11, wherein the blade-engaging retention features are selected from the group consisting of raised ridges, projecting teeth, serrations, and high-friction gripping elements.

13. The device of claim 11, wherein the blade-engaging retention features are composed of a material distinct from a material comprising the main body to alter a local coefficient of friction.

14. The device of claim 1, wherein the co-axial pair of finger-gripping indentations share a common central axis.

15. The device of claim 1, wherein a geometric profile of the first recessed indentation and the second recessed indentation is independently selected from the group consisting of an oval, a circle, a square, a rectangle, a polygon, and an ergonomic profile.
